(19) United States
(12) Patent Application Publication
(10) Pub. No.: US 2002/0098760 A1
(43) Pub. Date: Jul. 25, 2002

(54) Protective fabric

(76) Inventors: Michael Butterfield, Huntingdon (CA); Pierre Bissonnette, St-Andre d'Argenteuil (CA); Robert Brazeau, St-Stanislas-de Kostka (CA)

Correspondence Address: DRINKER BIDDLE & REATH, ONE LOGAN SQUARE, 18TH AND CHERRY STREETS, PHILADELPHIA, PA, 19103-6996, US

(21) Appl. No.: 09/859,318

(22) Filed: May 17, 2001

(30) Foreign Application Priority Data
Jan. 19, 2001 (CA) 2331955

(51) Int. Cl. B32B 5/02; B32B 27/04; B32B 27/12; D03D 15/00; D03D 25/00; B27N 9/00

(52) U.S. Cl. 442/209; 442/181; 442/136; 428/920; 428/921; 442/301; 442/208

(57) ABSTRACT

The present invention is a fabric for use for protective clothing especially for use by workers in the metal industry. The fabric consists of a first yarn of descaled wool and a second yarn of flame resistant viscose. The yarn is woven in a twill weave with the first yarn being to a greater extent on the surface of the fabric and the second yarn being to a greater extent to the back of the fabric. The fabric is treated with a low smoke flame resistant finish. The fabric contains no cotton.

### FIELD OF THE INVENTION

The present invention relates to the field of textiles, and particularly to textiles for use for protective clothing used for the metal industry.

### BACKGROUND OF THE INVENTION

Traditionally, employees working the hot metal industry wear protective clothing to prevent burns and other injuries from hot metal splash. The protective clothing is made from a number of different fabrics including wool and cotton. Each of these fabrics has a number of disadvantages. For example, wool has natural flame retardent properties and therefore is a good choice for providing protection from hot metal splash. However, wool can be uncomfortable to wear and therefore it is desirable to develop a fabric which retains the protective properties of the wool but is more comfortable to the wearer. In contrast to wool, cotton is comfortable to wear and easy to launder. However, it is flammable not fire retardent. Therefore it provides little protection to the user against hot metal splash. Cotton can be treated with a fire retardent product and does offer some advantages. However, once it is treated, it does not absorb moisture to cool the user and is considerably less comfortable than untreated cotton. As well, the fire retardent product washes out with repeated laundering and therefore is not practical for protective clothing which is used over an extended period of time.

PCT patent application WO 00/00686 describes a fabric for use in making protective clothing for the hot metal splash industry. It comprises a first yarn which consists of superwashed wool or a blend of superwash wool and a fire resistant synthetic material, and a second yarn which consists of a blend of a natural fibre other than wool and a fire resistant synthetic material. It is preferably made from a first yarn of wool/viscose and a second yarn of viscose/cotton. The blends are preferably 50:50. This patent application teaches that the fabric must be made from a blend of yarns in order to attain both hot metal splash protection and comfort to the user. However, cotton is flammable and therefore generally unsuitable or undesirable for use in hot metal industry environments. It is preferably that the fabric retain its comfort to the user and protection from hot metal splash without the use of cotton or other flammable material. As well, it is more expensive and difficult to manufacture a textile made from blends of yarns rather than from, for example, only two yarns.

There therefore is a need for a fabric to make protective clothing which will be comfortable to the user, fire retardent, provide protection from hot metal splash, is easy to launder, and inexpensive to manufacture.

### SUMMARY OF THE INVENTION

It is therefore an object of the present invention to overcome the disadvantages of the prior art and provide a textile for use for protective clothing which is comfortable to wear, fire retardent, easy to launder, and provides protection to the user.

There, therefore, is provided a fabric for use for protective clothing. The fabric has a surface and a back. It is comprised of a first yarn of two ply descaled wool, and a second yarn of flame resistant synthetic material. The first and second yarns are woven in a twill weave so that the first yarn is to a greater extent on the surface of the fabric and the second yarn is to a greater extent on the back of the fabric. The fabric is comprised of about 60-70% wool and about 30-40% flame resistant synthetic material.

In another aspect of the present invention, there is provided protective clothing made from this fabric.

### DETAILED DESCRIPTION OF THE INVENTION

There is provided a fabric consisting of a twill weave made from two yarns. The combination of these yarns along with the application of a low smoke flame resistant finish to the fabric provides the user with maximum protection and comfort.

The first yarn used in the fabric is a descaled wool. The wool is descaled, or specifically treated by “superwash” which allows the fabric to be commercially laundered while maintaining its protective characteristics. Wool has natural flame retardent properties and therefore provides protection to a user from hot metal splash. The wool is preferably a two ply yarn. Alternately, an intimate blend of wool and a fire resistant synthetic material such as viscose may be used.

Superwashing is a technique well known in the art. Briefly, the wool is partially descaled using a chlorine treatment and then each fibre is covered with a polymer resin. By descaling the wool fibre, the wool fibre has a reduced tendency to felt. Superwashing the wool also improves its washability characteristics.

The second yarn used in the fabric is a chemically treated flame resistant viscose. Suitable viscose includes Lenzing FR viscose. The viscose may be a single ply or a two ply yarn depending upon the weight of the resulting fabric and the protective clothing intended to be produced.

The two yarns are woven in a twill weave to form the fabric. The resulting fabric may, for example, be a three by one twill or a two by one gabardine. The wool is woven in the warp direction and the viscose in the weft direction. The yarns are woven so that a greater percentage of the wool is on the surface of the garment to maximize the protective qualities of the fabric. A greater percentage of the viscose is woven on the back of the fabric to maximize the comfort of the fabric to the user. Preferably, the fabric is woven with the surface of the fabric containing about 65-70% wool and about 30-35% flame resistant viscose. The back of the fabric contains about 30-35% wool and about 65-70% flame resistant viscose.

The low smoke finish is applied to the fabric in any manner commonly known and used in the art. After dyeing the wool, it is treated with a zirconium complex which is applied by the exhaustion technique at low temperature. In one example of the exhaustion technique, the fabric is immersed in a solution containing salt and zirconium. Acids are added to reduce the pH to levels below 3. The temperature is gradually raised to 70° C. and maintained at 70° C. for up to 45 minutes. After this step, bromine salt is precipitated on the fibre under controlled pH and temperature. The combination of these two chemical treatments impacts superior flame resistance in the fabric. As well, the resulting treated fabric retains its colour and flame resistant treatment when washed or commercial dry cleaned.

Overall, the resulting fabric is greatly improved over the prior art fabrics. The blend of superwashed wool and flame resistant viscose in a weave which increases the amount of wool on the surface of the fabric and increases the amount of viscose on the back of the fabric results in a fabric which is economical to manufacture, retains its protective properties, and is more comfortable to wear than prior art fabrics. The fabric offers significantly increased protection and comfort to the user over prior art fabrics. The fabric has very good washability characteristics and its tendency to felt is reduced. It can be washed at higher temperatures than regular wool with the benefit that there is better results in removing stains, less need to dry clean the resulting clothing, and therefore resulting clothing can be washed at home by the user. The fabric retains its colour and flame resistant properties during repeated washing or dry cleaning. The fabric has these improved characteristics over the prior art fabrics.

### EXAMPLES

Light Weight Fabric

A light weight twill protective fabric is preferred for use as a shirting fabric for protective clothing. Such a lightweight fabric has a weight of preferably about 256 grams per square meter. It is constructed so as to provide maximum protection against molten metal splash. The fabric preferably uses a single ply viscose as the second yarn to reduce the weight. The weave of the fabric is a three by one twill. A two ply (2/40) descaled wool is used in the warp direction at a concentration of 81 yarns per inch. A single ply flame resistant viscose (1/34) yarn is used in the weft direction at a concentration of 62.5 yarns per inch.

The weave of the fabric places a greater percentage of the wool warp yarn on the surface of the fabric. This weave maximizes the protection against molten metal splash. The flame resistant viscose is, to a greater percentage, on the back of the fabric. This weave offers a softer feel and comfort to the user. The preferred overall content of the fabric is 67% wool and 33% viscose.

Medium Weight Fabric

A medium weight fabric may be preferred for protective pants. Such a medium weight fabric has a weight of approximately 344 grams per square meter. The fabric preferably uses a two by one gabardine. A two ply (2/29) descaled wool is used in the warp direction at a concentration of 74 yarns per inch. A two ply (2/34) flame resistant viscose is used in the weft direction at a concentration of 48 yarns per inch. The weave of the fabric is preferably a two by one gabardine. The weave places a greater percentage of the wool warp yarn on the surface of the fabric to maximize the protection to the user from hot metal splash. The viscose is, to a greater extent, on the back of the fabric to increase the comfort to the user and provide a softer feel to the garment. The overall preferred content of the fabric is approximately 65% wool and 35% viscose.

The fabric may be used to produce protective clothing for the hot metal splash industry or other industries where there is a possibility of heated liquid splashing onto workers. The present invention therefore includes clothing made from the present fabric.

The above-described embodiments of the present invention are meant to be illustrative of preferred embodiments of the present invention and are not intended to limit the scope of the present invention. Various modifications, which would be readily apparent to one skilled in the art, are intended to be within the scope of the present invention. The only limitations to the scope of the present invention are set out in the following appended claims.

We claim:

1, A fabric for use in protective clothing, the fabric having a surface and a back, the fabric comprising:
a first yarn of a two ply descaled wool, and
a second yarn of flame resistant synthetic material, wherein the first and second yarns are woven in a twill weave so that the first yarn is to a greater extent on the surface of the fabric and the second yarn is to a greater extent on the back of the fabric.

2. The fabric of claim 1 wherein the synthetic material is viscose.

3. The fabric of claim 2 wherein the viscose is a two ply flame resistant viscose.

4. The fabric of claim 2 wherein the viscose is a single ply flame resistant viscose.

5. The fabric of claim 1 further treated with a low smoke flame resistant finish.

6. The fabric of claim 1 wherein the twill weave is a three by one twill weave.

7. The fabric of claim 1 wherein the fabric is a two by one gabardine.

8. The fabric of claim 1 wherein the fabric is comprised of about 60-70% wool and about 30-40% viscose.

9. The fabric of claim 8 wherein the fabric is comprised of about 67% wool and about 33% viscose.

10. The fabric of claim 8 wherein the fabric is comprised of about 65% wool and about 35% viscose.

11. A fabric for use in protective clothing, the fabric having a surface and a back, the fabric comprising:
a first yarn comprising a descaled wool or an intimate blend of a descaled wool and a flame resistant synthetic material, and
a second yarn of flame resistant synthetic material, wherein the first and second yarns are woven in a twill weave so that the first yarn is to a greater extent on the surface of the fabric and the second yarn is to a greater extent on the back of the fabric.

12. A fabric for use in protective clothing, the fabric having a surface and a back and containing no cotton, the fabric comprising:
a first yarn comprising a descaled wool, and
a second yarn of flame resistant viscose,
wherein the first and second yarns are woven in a twill weave so that the first yarn is to a greater extent on the surface of the fabric and the second yarn is to a greater extent on the back of the fabric, and wherein the surface of the fabric contains about 60%-70% wool and the back of the fabric contains about 30%-40% viscose; and
wherein the fabric is treated with a low smoke finish.

13. Clothing made from the fabric as claimed in claim 1.
